(19) United States
(12) Patent Application Publication
(10) Pub. No.: US 2014/0244294 A1
(43) Pub. Date: Aug. 28, 2014

(54) Apparatus and Method for Network Based Remote Mobile Monitoring of a Medical Event

(71) Applicant: MEDLERT, INC., San Francisco, CA (US)

(72) Inventors: David Emanuel, San Francisco, CA (US); Ernest W. Semerda, Mountain View, CA (US)

(73) Assignee: Medlert, Inc., San Francisco, CA (US)

(21) Appl. No.: 13/776,585

(22) Filed: Feb. 25, 2013

(51) Int. Cl. G06F 19/00; G06Q 50/24

(52) U.S. Cl. CPC G06F 19/3481; G06Q 50/24
USPC 705/3

(57) ABSTRACT

A server includes a processor and a memory connected to the processor. The memory stores instructions executed by the processor. The instructions receive medical event data from a mobile device, an identification for a patient and mobile device parameters. The identification for the patient is matched with medical records and response rules for the patient. The response rules are executed to selectively notify a civic responder and an incident management module. Communications with the patient and specified emergency contacts associated with the patient are coordinated.

### FIELD OF THE INVENTION

This invention relates generally to medical care. More particularly, this invention relates to techniques for network based remote mobile monitoring of a medical event.

### BACKGROUND OF THE INVENTION

Improving healthcare is a universally valued goal. There are ongoing needs to improve the quality of individual care, response time in the event of a medical incident, initial evaluation of conditions in the event of a medical incident and effective communication with a patient and a patient's network of friends and family in the event of a medical incident.

### SUMMARY OF THE INVENTION

A server includes a processor and a memory connected to the processor. The memory stores instructions executed by the processor. The instructions receive medical event data from a mobile device, an identification for a patient and mobile device parameters. The identification for the patient is matched with medical records and response rules for the patient. The response rules are executed to selectively notify a civic responder and an incident management module. Communications with the patient and specified emergency contacts associated with the patient are coordinated.

A mobile device includes a processor and a memory connected to the processor. The memory stores instructions executed by the processor. The instructions receive monitor data, compare the monitor data to predetermined medical event thresholds to selectively identify a triggering event, and communicate, in response to the triggering event, medical event data, an identification for a patient and mobile device parameters to a networked incident management server.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates an incident report utilized in accordance with an embodiment of the invention.

Like reference numerals refer to corresponding parts throughout the several views of the drawings.

### DETAILED DESCRIPTION OF THE INVENTION

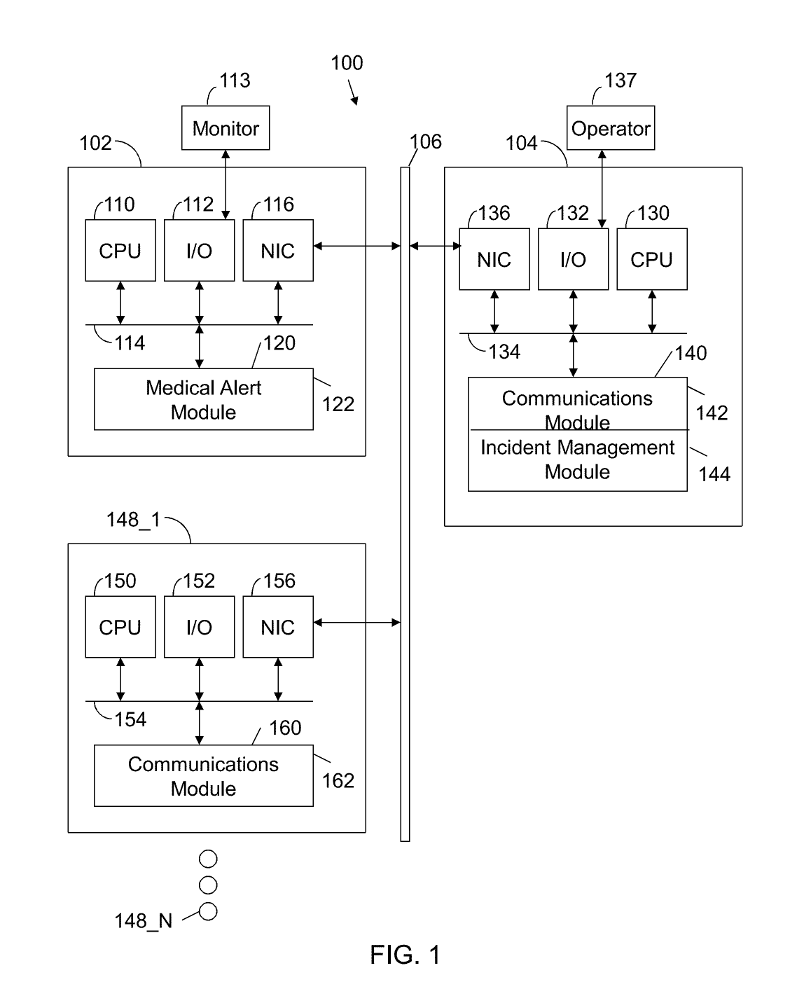

FIG. 1 illustrates a system 100 configured in accordance with an embodiment of the invention. The system 100 includes a mobile device 102 in communication with a server 104 via a network 106. The mobile device 102 may be a mobile telephone, Smartphone, tablet and the like. The mobile device 102 includes standard components, such as a central processing unit 110 and input/output devices 112 coupled via a bus 114. The input/output devices 112 may include a keyboard, touch display, a microphone, a speaker and the like. The input/output devices 112 may also include ports for wired or wireless communications with a monitor 113 coupled to the mobile device 102. The monitor may be a heart monitor, a glucose monitor or any other type of healthcare monitor. There is a growing list of medical monitors that may be used in conjunction with mobile devices 102. Any such device can be used in accordance with the invention.

A network interface circuit 116 is also connected to the bus 114. The network interface circuit 116 provides a communication channel with network 106, which is a wireless network, but may include various wired connections.

A memory 120 is also connected to the bus 114. The memory 120 stores a medical alert module 122. The medical alert module 122 includes executable instructions to implement operations of the invention. The medical alert module includes instructions to coordinate communications with server 104. In addition, the medical alert module includes instructions to identify a medical incident. For example, predetermined thresholds may be defined for an appropriate blood glucose level. If a threshold is passed, a triggering event occurs, as will be discussed below. Alternately, predetermined thresholds may be defined for proper heart rate activity. A threshold value may also be specified to identify a fall by a patient. For example, an accelerometer associated with the mobile device 102 may be monitored to compare accelerometer output signals to predetermined signal patterns indicative of a fall by a patient. The accelerometer may also be used in connection with a threshold associated with no movement. For example, a lack of movement for five hours during daytime may trigger communications with server 104.

The server 104 also includes standard components, such as a central processing unit 130, input/output devices 132, a bus 134 and a network interface card 136. A memory 140 is also connected to the bus 134. The memory 140 stores executable instructions to implement operations of the invention. In one embodiment, the executable instructions include a communications module 142 with executable instructions to coordinate communications between the server 104 and the mobile device 102, as discussed below. The communications module 142 may also be configured to coordinate communications with a live operator 137 through one or more input/output ports 132. The live operator 137 may be at a dispatch or monitoring center associated with the server 104 or in communication with the server 104 through network 106.

An incident management module 114 operates in conjunction with the communications module 142 to coordinate a response to a medical incident, as discussed below. The operations of the communications module 142 and the incident management module 144 may be combined. Furthermore, these operations may be distributed across several machines.

FIG. 1 also illustrates a variety of machines 148_1 through 148_N. Each machine includes standard components, such as a central processing unit 150, input/output devices 152, a bus 154 and a network interface circuit 156. A memory 160 is connected to the bus 154. The memory 160 includes a communications module 162. This module allows the receipt of information from the server 104. The machines 141_1 through 148_N may be mobile devices, tablets, personal computers and the like. The machines are passive in the sense that they operate to receive information about a medical incident, as discussed below.

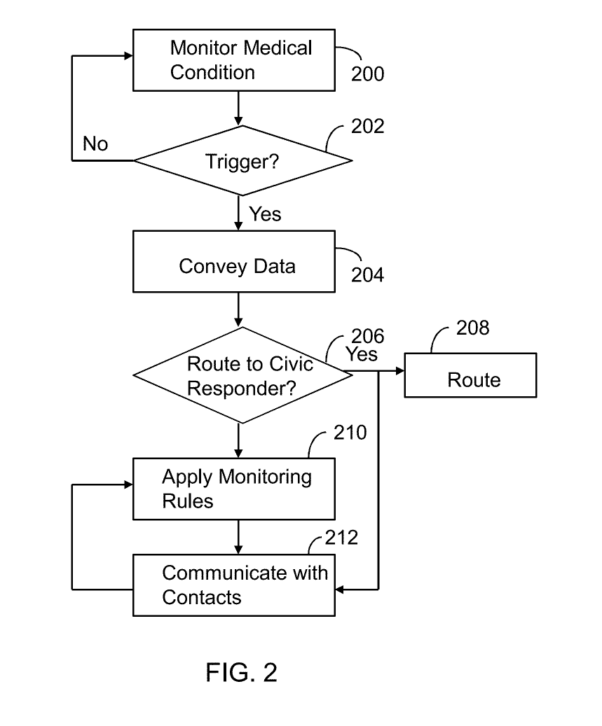

FIG. 2 illustrates processing operations associated with an embodiment of the invention. Initially, a medical condition is monitored 200. This operation is performed by the medical alert module 122. For example, the medical alert module may be configured through a series of user prompts to define a medical condition to be monitored. After configuration, the specified medical condition is monitored against the specified thresholds. For example, in the case of monitoring heart rate, a measured heart rate is compared to low and/or high heart rate thresholds. The heart rate monitor may be connected to the mobile device 102 through a wired or wireless (e.g., Bluetooth®) connection.

The medical alert module 122 includes executable instructions to track the output of such a monitor and compare tracked values to specified thresholds. The monitoring may also be performed in connection with a blood glucose monitor connected to the mobile device 102 through a wired or wireless connection. Again, specified blood glucose thresholds may be defined and then compared to the output of the blood glucose monitor. Alternately, internal resources of the mobile device 102 may be used to monitor a medical condition. For example, the mobile device accelerometer may be used for fall detection. The mobile device accelerometer may also be used to identify movement after a fall. Such information may be useful in accessing the severity of the fall. The medical alert module 122 may be configured with a library of accelerometer signal signatures indicative of a fall. Alternately, the monitored medical condition may simply be a button on the mobile device, which when pressed by the user, indicates a medical condition. In response to activation of the button, the mobile device may receive on its screen a prompt for information (e.g., Chest pain? Fever? Breathing problem?). The monitored medical condition may also be triggered through voice activation (e.g., an uttered “Help!”). Alternately, a medical condition may be triggered if the user of the mobile device exits a geographically fenced area.

The next operation of FIG. 2 is to determine whether the monitored medical condition triggers a specified medical threshold 202. If not (202—No), then control returns to block 200. If so (202—Yes), data is conveyed to a networked incident management server. For example, the medical alert module 122 may contact the server 104 and pass along a variety of information. The information may include information on the medical event (e.g., a fall, an elevated heart rate, a low glucose level). A patient identifier is also passed along. In one embodiment, mobile device parameters are also conveyed. These mobile device parameters may include mobile device location data, which allows a coordinated response based upon physical location. Other mobile device parameters may include mobile device battery life and mobile device signal strength. Such signals may be used to develop a communication plan with the patient. For example, if the signals are low, then immediate high priority communications may be invoked. If the signals are strong, an extended communication protocol may be used.

The communications module 142 and/or the incident management module 144 receives the medical event data, the identification for the patient and the mobile device parameters. The identification for the patient is used to retrieve medical records for the patient. The medical records may be complete medical records for the patient stored at the server 104 or may be a sub-set of medical records for the patient relevant to the incident. Response rules for the patient may also be retrieved. The response rules may be pre-configured for the specific patient. Alternately, the response rules may be default rules for the specified incident.

The incident management module 144 decides whether the medical incident merits immediate intervention by a civic responder (e.g., the fire department or an ambulance). For example, a pre-defined low blood glucose level for a specific patient may be associated with a response rule of immediately invoking a civic responder. Alternately, a specified low blood glucose level for any patient may result in a response rule of immediately invoking a civic responder.

If a civic responder is required (206—Yes), a 911 dispatch center may be contacted 208. Advantageously, the incident management module 144 includes a mapping of physical locations to appropriate 911 responders. That is, the incident management module 144 maps the mobile device location data to the physical locale of the geospatially closest 911 responder. This stands in contrast to the scenario where a mobile device user dials 911 and is directed toward a national dispatch center, which then determines an appropriate local responder. The disclosed technique improves response time.

The civic responder may be routed a set of information, including the medical event data, patient location information and patient information. Alternately, or in addition, the incident management module 144 may be associated with a live operator 137 who orally conveys relevant information to the civic responder.

In one embodiment, contacting a civic responder immediately results in communications with contacts 212. This operation is discussed below. If a civic responder is not contacted, or alternately even if a civic responder is contacted, the incident management module 144 may continue to apply monitoring rules 210. The monitoring rules specify a protocol for communicating with the patient and for the continued collection of information (e.g., medical condition, device information, such as battery life, device location from GPS signal, etc.) for a specified period of time. For example, the monitoring rules may specify a reading from the accelerometer of the mobile device 102 to determine if the patient has moved after a fall. The monitoring rules may specify the ongoing reading and tracking of the patient heart rate. The monitoring rules may also specify operator intervention activities, such as initiating a call to the mobile device to check on the status of the patient. The call may be an audio call or a video call. Alternately, the monitoring rules may specify an SMS text exchange protocol. For example, an initial SMS text from the server 104 may have simple inquiries (e.g., Are you OK? Do you need help?), which the patient may respond to by clicking on a link or generating a responsive text. The monitoring rules may specify that a patient's failure to respond may be deemed a basis for escalating the medical response. For example, if a civic responder was not previously contacted, a decision may be made to do so in view of the lack of feedback from the patient.

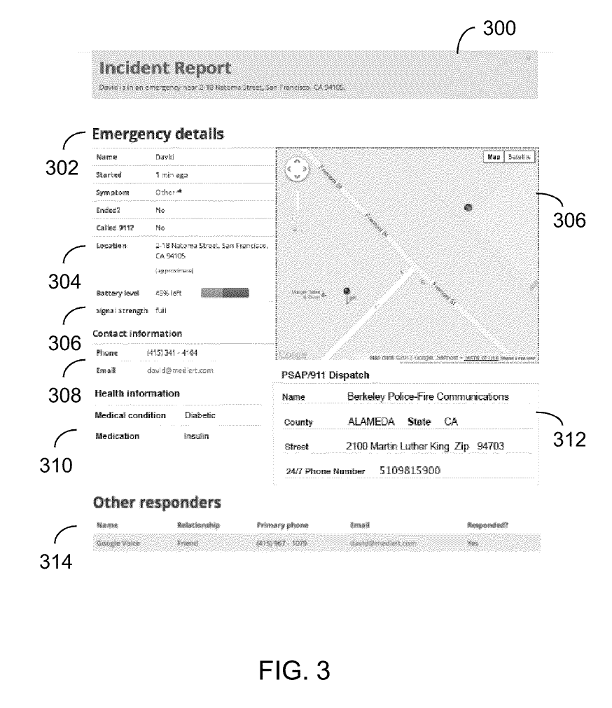

The incident management module 144 forms an incident report 300, such as shown in FIG. 3. The incident report 300 may be displayed to operator 137 and/or be supplied to a responder, as discussed below. In this embodiment, the incident report 300 includes emergency details 302, such as the name of the patient, when the incident started, symptoms associated with the incident, whether the incident has ended and whether the patient has been contacted. Location data 304 may also be provided. The location data may be based upon the mobile device location data. The location data 304 may be accompanied by a map 306. The map 306 may be accompanied by panoramic and street-level imagery.

The incident report 300 also includes mobile device parameters 306, in this case, battery life and signal strength. Contact information 308 for the patient is also supplied in this example of an incident report. If a civic responder has been contacted, the identity of the civic responder 312 may also be supplied. The map 306 may include indicia of the locations of the patient and the civic responder. The report may also specify whether the patient has acknowledged the incident.

Other responders 314 may also be included in the report 300. The other responders may be pre-selected individuals (e.g., friends and family) that should be contacted in the event of a medical incident. The incident management module 144 may specify rules for communicating with other responders. For example, some responders may receive a telephone call. The telephone call may be an automated call or may be a call from the operator 137. Some responders may receive an SMS text notification with some details related to the incident. Other responders may receive an email notification with an incident report, such as incident report 300. The responders may be required to confirm receipt of a report, e.g., by acknowledging a unique link in a report.

Those skilled in the art will appreciate that the disclosed invention provides improved quality of medical care. First, response time is improved through active monitoring of a medical condition (in contrast to a long-delayed self-reported affliction). Medical information may be quickly coordinated at the server. Pre-established best practices protocols may be automatically used in response to the medical incident. Finally, the invention provides for automated communication with a patient and a patient's network of friends and family in the response to the medical incident. This improves the quality of care for the patient and affords friends and family to assist in the medical response.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks,; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions. The server 104 may be a node in “the cloud”.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A server, comprising:
a processor; and
a memory connected to the processor, the memory storing instructions executed by the processor, wherein the instructions:
receive medical event data from a mobile device, an identification for a patient and mobile device parameters,
match the identification for the patient with medical records and response rules for the patient,
execute the response rules to selectively notify a civic responder and an incident management module, and
coordinate communications with the patient and specified emergency contacts associated with the patient.

2. The server of claim 1 wherein the memory stores instructions executed by the processor to continuously receive medical event data updates from the mobile device for a specified period of time.

3. The server of claim 1 wherein the medical event data indicates a fall by the patient.

4. The server of claim 1 wherein the medical event data indicates a heart rate abnormality for the patient.

5. The server of claim 1 wherein the medical event data indicates a glucose abnormality for the patient.

6. The server of claim 1 wherein the mobile device parameters are selected from mobile device location data, mobile device battery life and mobile device signal strength.

7. The server of claim 1 wherein the response rules include rules to follow a predetermined communication protocol based upon the medical event data.

8. The server of claim 1 wherein the response rules include rules to follow a predetermined communication protocol based upon the mobile device parameters.

9. The server of claim 1 wherein the incident management module prepares an incident report for display.

10. The server of claim 1 wherein the executable instructions to coordinate communication with the patient include executable instructions to initiate one or more of a telephone call, a video call and a text exchange.

11. The server of claim 1 wherein the executable instructions to coordinate communication with the specified emergency contacts include executable instructions to initiate one or more of a telephone notification, an email notification and a text notification.

12. A mobile device, comprising:
a processor; and
a memory connected to the processor, the memory storing instructions executed by the processor, wherein the instructions:
receive monitor data,
compare the monitor data to predetermined medical event thresholds to selectively identify a triggering event, and
communicate, in response to the triggering event, medical event data, an identification for a patient and mobile device parameters to a networked incident management server.

13. The mobile device of claim 12 wherein the memory stores instructions executed by the processor to continuously send medical event data updates to the networked incident management server for a specified period of time.

14. The mobile device of claim 12 wherein the monitor data is an accelerometer signal from within the mobile device.

15. The mobile device of claim 12 wherein the monitor data is from a heart rate monitor coupled to the mobile device.

16. The mobile device of claim 12 wherein the monitor data is from a glucose monitor coupled to the mobile device.

17. The mobile device of claim 12 wherein the mobile device parameters are selected from mobile device location data, mobile device battery life and mobile device signal strength.

18. The mobile device of claim 12 wherein the memory stores instructions executed by the processor to receive one or more of a telephone call, a video call and a text exchange from the networked incident management server.
